(19) United States
(12) Patent Application Publication
(10) Pub. No.: US 2009/0251491 A1
(43) Pub. Date: Oct. 8, 2009

(54) METHOD OF DEPICTING AN IMAGE

(75) Inventors: Michael J. Merifield, Fish Hoek (ZA); Michael John Walter Brown, Pinelands (ZA)

Correspondence Address: REED SMITH LLP, P.O. BOX 488, PITTSBURGH, PA, 15230-0488, US

(73) Assignee: THREE D-SIGNS INTERNATIONAL LIMITED, London (GB)

(21) Appl. No.: 12/297,039

(22) PCT Filed: Apr. 19, 2006
(86) PCT No.: PCT/GB2006/001344

§ 371 Date: May 12, 2009

(30) Foreign Application Priority Data
Apr. 13, 2006 (TT) TT/A/2006/00058

(51) Int. Cl. G09G 5/00

(52) U.S. Cl. 345/647

(57) ABSTRACT

A method of depicting an image at a predetermined image position comprises the step of transforming an original image using an image transformation process, the image transformation process being adapted to transform the original image according to a positional relationship between the predetermined image position and a predetermined viewing position. One or more surface characteristics of an image surface (3) at the predetermined image position are determined, and used to adapt the image transformation process. In its simplest form, the invention characterises the image surface (3) as a single plane. Any orientation that the plane of the image surface (3) may take up in three-dimensional space is quantified in terms of the degree of rotation that the plane of the image surface takes from that of a horizontal plane (5), separately, about the transverse axis (9) and/or the longitudinal axis (11) passing through a focal point in the image. The image surface may also be partitioned into a plurality of sections, each section being quantified in terms of the degree of rotation that the plane of each section takes. The transformed image is placed on the image surface at said predetermined image position. The invention also provides an improved method of applying an image using a template.

### FIELD OF THE INVENTION

The present invention relates to a method of depicting an image, and in particular to a method of depicting an image in a manner that is optimised for viewing from a predetermined viewing position relative to a predetermined image position. More particularly, but not exclusively, the invention relates to the depiction of images of an advertising or promotional nature at sporting events, which may be viewed through an image capturing and/or transmitting device, such as a television camera.

### BACKGROUND OF THE INVENTION

Images of an advertising or promotional nature have traditionally been placed on perimeter advertising boards or the like. However, over recent years sponsors of sporting events have been adapting their advertising methods to make the most of incidental exposure through televised broadcasts.

In particular, this is true of in-stadia advertising at sporting events where both the positioning and creative design of the branding of the sponsor is being increasingly influenced by the resulting legibility of the branding in the televised image.

Although the desire to improve the legibility of the sponsors' branding applies to all of the various tiers of perimeter advertising around the field of play, the most obvious advance to have been made in this regard relates to on-field branding. The present applicant has patented a method which transforms an image corresponding to the branding or logo of a sponsor in accordance with the positional relationship that exists between a predetermined viewing position (for example corresponding to the position of a television camera) and a predetermined image position corresponding to the position where the image is to be placed (for example, near the side lines of a football pitch, in the centre of a rugby pitch, or in line with the wickets on a cricket field).

Thus, the transformation described in the patented method enables a two dimensional image positioned on a surface to appear three dimensional when viewed from its corresponding predetermined viewing position. In this way, a TV audience can be presented with an accurate image of a sponsor's branding.

It will be appreciated that, from an advertising perspective, the TV audience is far more significant than the spectators located within the stadium itself. The method described in the patented method enhances the advertising effect for the TV audience in a number of ways. For example, it enables the logo of a sponsor to be positioned closer to the televised action. In other words, the method has the effect of making the sponsor's logo much more visible to the viewing audience while a particular sport is being played. The known method also has the advantage of providing a “true” image of the relevant brand or logo rather than a distorted image, to the viewer as previously found.

It will also be appreciated that the patented method enables advertising images to be placed in locations where previously it was not beneficial to place advertising material, thereby increasing the amount of valuable advertising space that is available at a particular venue or stadium. This is made possible by the fact that the image can be depicted in a two dimensional format, while still providing a three dimensional image to the viewing TV audience.

However, the method described above suffers from the disadvantage that the viewed image can still appear to a viewer to be distorted if the surface characteristics of the predetermined image position have some form of flaw, such as being irregular (i.e. not flat) or non-horizontal with respect to the predetermined viewing position.

It is an aim of the present invention to provide an improved method for depicting an image.

### SUMMARY OF THE INVENTION

According to a first aspect of the present invention, there is provided a method of depicting an image at a predetermined image position. The method comprises the steps of transforming an original image using an image transformation process, the image transformation process being adapted to transform the original image according to a positional relationship between the predetermined image position and a predetermined viewing position, thereby creating a transformed image for placement on an image surface at said predetermined image position. The step of transforming the original image includes the steps of determining one or more surface characteristics of the image surface, and adapting the image transformation process according to the one or more surface characteristics of the image surface.

According to another aspect of the present invention, there is provided an improved method of applying a transformed image to an image surface using a template, wherein the template size is smaller than the size of the transformed image. Preferably the transformed image is separated into two or more sections, each section being overlaid on the same template.

### BRIEF DESCRIPTION OF THE DRAWINGS

For a better understanding of the present invention, and to show more clearly how it may be carried into effect, reference will now be made to the following drawings in which:

FIG. 1 illustrates the ‘simple’ case of an image surface according to the prior art, i.e. flat and horizontal with respect to the predetermined viewing position;

FIG. 2 illustrates how the plane of an image surface may lie in a plane that is not horizontal with respect to the predetermined viewing position but has been rotated towards or away from the predetermined viewing position about a transverse axis;

FIG. 3 illustrates how the plane of an image surface may lie in a plane that is both rotated towards or away from the predetermined viewing position about a transverse axis, as well as rotated clockwise or anti-clockwise with respect to the predetermined viewing position about a longitudinal axis;

FIG. 4 illustrates a flat image surface used for transforming an image according to the prior art;

FIG. 5 illustrates how the image surface may comprise one or more bumps;

FIG. 6 illustrates how the image surface may comprise one or more dips;

FIG. 7 illustrates the relationship between the predetermined viewing position and the predetermined image position when the image surface is flat and horizontal;

FIG. 8 illustrates how an image having a rectangular shape is depicted according to the prior art;

FIG. 9 shows the transformed image that is used to produce the image shown in FIG. 8;

FIGS. 10a and 10b are diagrammatic side and plan views respectively, to show the symbols used in the mathematical equations used in the inverse perspective transformation of an image from a focal plane to a ground plane.

FIG. 11 illustrates the relationship between the predetermined viewing position and the predetermined image position when the image surface lies in a plane that is rotated about a transverse axis;

FIG. 12 illustrates how an image having a rectangular shape is depicted in relation to an image surface that lies in a plane that is rotated about a transverse axis as shown in FIG. 11;

FIG. 13 shows the transformed image that is used to produce the image shown in FIG. 12;

FIG. 14 illustrates the relationship between the predetermined viewing position and the predetermined image position when the image surface lies in a plane that is rotated about a longitudinal axis;

FIG. 15 illustrates how an image having a rectangular shape is depicted in relation to an image surface that lies in a plane that is rotated about a longitudinal axis as shown in FIG. 14;

FIG. 16 shows the transformed image that is used to produce the image shown in FIG. 15;

FIG. 17 shows an example of an original image;

FIG. 18 shows a transformed image corresponding to the original image shown in FIG. 17;

FIG. 19 shows how the transformed image of FIG. 18 is partitioned into a plurality of sections;

FIG. 20 shows a template according to a second aspect of the present invention;

FIG. 21 shows how the template of FIG. 20 comprises a top portion of the transformed image of FIG. 18;

FIG. 22 shows how the template of FIG. 20 comprises a middle portion of the transformed image of FIG. 18;

FIG. 23 shows how the template of FIG. 20 comprises a bottom portion of the transformed image of FIG. 18.

To assist in the understanding of the invention described in the following text and claims, the following definitions have been given to certain terms:

Predetermined image position—the position at which an image is to be placed for viewing, for example next to the side lines on a football pitch, in the centre of a rugby pitch, in line with the wickets on a cricket pitch, and so on.

Predetermined viewing position—the position at which the image is to be viewed, for example the location of a television camera.

Image surface—the surface on which an image is to be placed at the predetermined image position.

Plane of the image surface—an imaginary plane corresponding to the plane in which the image surface lies.

Line of sight—imaginary line extending from the predetermined viewing position towards the predetermined image position.

Original image—this is the image that is intended to be presented to the end viewer. For example, the original image may be an advertising image such as a logo of a sponsor, and relates to the image as it would appear on a two dimensional surface normal to the line of sight of the viewer.

Transformed image—this is the image after being transformed according to the invention (i.e. in relation to the positional relationship between the predetermined image position and the predetermined viewing position, and the surface characteristics of the image surface), and relates to the image that is actually depicted on the image surface at the predetermined image position.

Viewed image—this is how the transformed image appears when viewed from the predetermined viewing position, i.e. the Original image. Inverse Perspective Transformation—Any transformation of the original image which compensates for one or more of the effects of natural perspective, thereby having the effect of making a two dimensional original image appear three dimensional as a viewed image, and including at least one of:
stretching the image along the line of sight;
increasing the spacing of image features along the line of sight (i.e. equal distances in the original image become increasingly larger in the transformed image as they move away from the predetermined viewing position along the line of sight); and
diverging lines that appear parallel in the original image, as they extend away from the predetermined viewing position along the line of sight; or
any combination of the above.

Horizontal plane—an imaginary plane which is parallel to an imaginary plane of the predetermined viewing position, the plane of the predetermined viewing position being a plane which is normal to a plumb line dropped from the predetermined viewing position.

Normal vector to the horizontal plane—is any vector that has a direction that is orthogonal (perpendicular) to the surface of the Horizontal plane.

Transverse axis—an imaginary axis that is transverse to the direction of the Line of sight and which lies in the Horizontal plane, passing thorough the Focal point.

Longitudinal axis—an imaginary axis which lies in the Horizontal plane and which passes through the Focal point in a direction that is 90 degrees to that of the transverse axis.

Focal point—a point on the predetermined viewing position, through which both the transverse and longitudinal axes pass, and from which various analytical information is measured. The Focal point lies on the Horizontal plane and indeed on every plane arising from a rotation of the Horizontal plane about either or both of the Transverse and Longitudinal axes.

### DETAILED DESCRIPTION OF A PREFERRED EMBODIMENT OF THE PRESENT INVENTION

As mentioned in the background section, the applicant's patented method assumes that the image surface 3 at the predetermined image position lies in an imaginary plane which is both flat and horizontal with respect to a horizontal plane 5 corresponding to a predetermined viewing position, as shown in FIG. 1. The patented methodology relates to creating an inverse perspective transformation for such a surface. The inverse perspective transformation is carried out in accordance with mathematical formulae that take into account the vertical height of a predetermined viewing position (not shown) above the image surface 3 of the predetermined image position, as well as the horizontal distance of the predetermined viewing position from a focal point 7 in the predetermined image position.

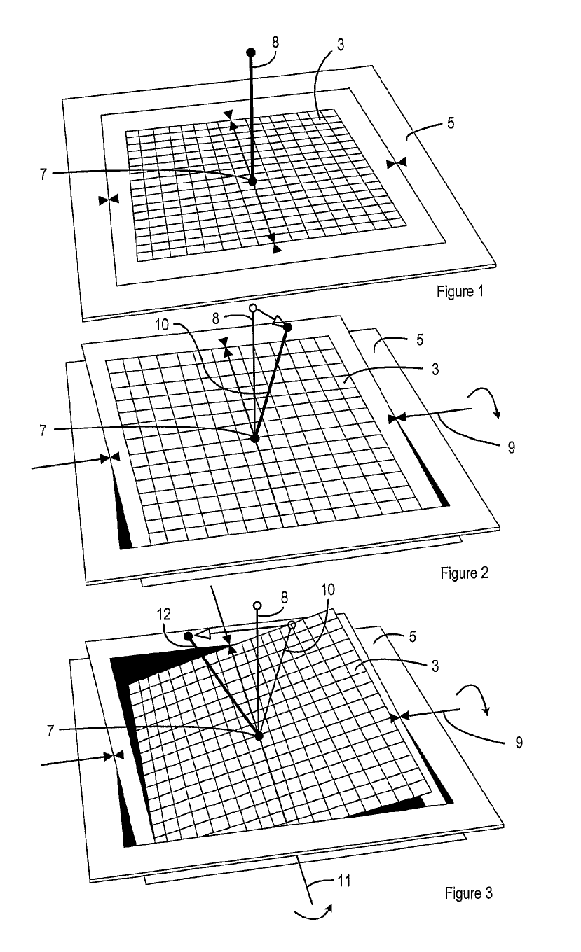

FIG. 2 illustrates how the image surface 3 at the predetermined image position can lie in a plane that is non horizontal with respect to the predetermined viewing position. For example, the image surface 3 at the predetermined image position may differ from the horizontal plane 5 by some degree of rotation either towards or away from the predetermined viewing position around a transverse axis 9 passing through the focal point 7.

Referring to FIG. 3, it can be seen how the image surface 3 at the predetermined image position can also differ from the horizontal plane 5 by some degree of rotation either clockwise or anticlockwise around a longitudinal axis 11 passing through the focal point 7, or indeed a combination of both of the above as shown in FIG. 3. In FIG. 3 the plane of the image surface 3 is rotated about transverse axis 9 towards the predetermined viewing position, and also rotated anticlockwise about longitudinal axis 11.

It will therefore be appreciated from the above that the plane of the image surface 3 may exist at any orientation in three-dimensional space. The following is a more detailed explanation of what is meant by a surface that exists at any orientation in three-dimensional space with respect to the viewing position. There is documented mathematical theory relating to points, vectors and planes in three-dimensional space. Of particular relevance is the concept of “normality” that may be defined as follows:

In three-dimensional space, a vector is said to be “normal” to a plane, if the vector has a direction that is orthogonal (perpendicular) to the surface of the plane.

Consider a typical situation in three-dimensional space where an elevated camera is provided for imaging a surface with a focal point on the surface.

There are an infinite number of planes passing through the focal point, however, only one of these planes can be said to be horizontal with respect to the camera position.

Referring again to FIG. 1, this is the plane 5 to which a vertical plumb line dropped from the camera position is normal. A vector 8 normal to the horizontal plane 5 through the focal point 7 will have the same direction as the plumb line dropped from the camera.

The focal point 7 lies on the horizontal plane 5, but it also lies on the image surface 3. If the image surface 3 and the horizontal plane 5 are one and the same, as shown in FIG. 1, then the image surface 3 can be said to be horizontal with respect to the camera position. In this case the image surface 3 and the horizontal plane 5 will have the same normal vector 8 through the focal point 7.

In most practical applications encountered in providing on-field branding at televised sports events, however, the image surface 3 is not horizontal with respect to the camera position, as explained above in relation to FIGS. 2 and 3. In FIG. 2, a vector 10 normal to the image surface 3 through the focal point 7 will not have the same direction as the vector 8 normal to the horizontal plane 5 through the focal point 7. Similarly, in FIG. 3, a vector 12 normal to the image surface 3 through the focal point 7 will not have the same direction as the vector 10 shown in FIG. 2 (i.e. having rotation just about the transverse axis 9), or the vector 8 which is normal to the image surface 3.

In other words, when observed from the camera position, the image surface 3 may differ from the horizontal plane 5 by some degree of rotation either towards or away from the camera around a transverse axis 9 passing through the focal point 7, or by some degree of rotation either clockwise or anticlockwise around a longitudinal axis 11 passing through the focal point 7, or indeed a combination of both of these (as shown in FIG. 3).

Any orientation that the image surface 3 may take up in three-dimensional space can be resolved in terms of the degree of rotation that the image surface 3 takes from that of the horizontal plane 5 firstly, about the transverse axis 9 and secondly about the longitudinal axis 11, both passing through the focal point 7.

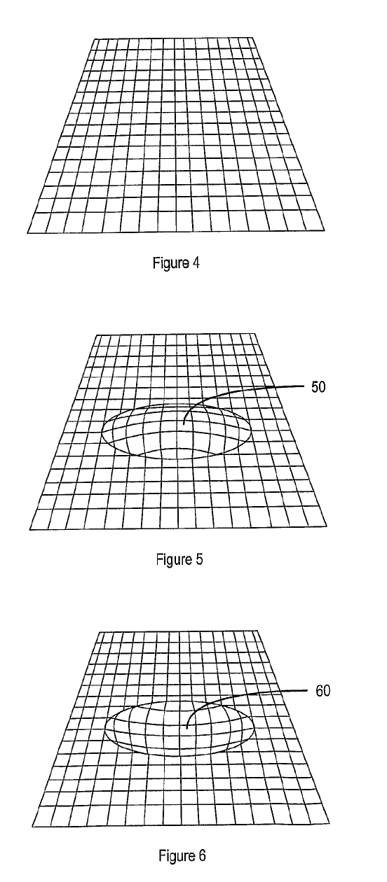

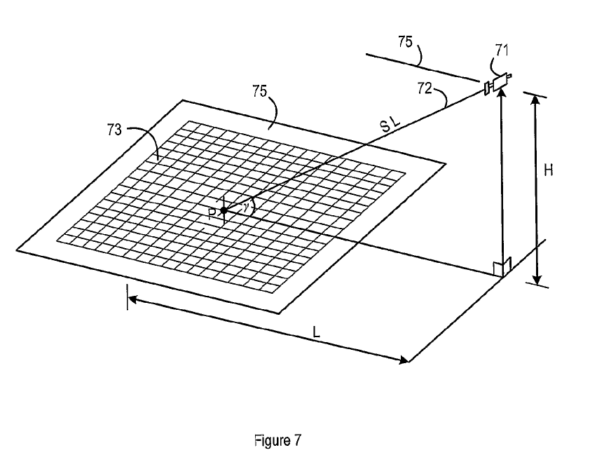

In addition to the image surface 3 lying in a plane that is generally non-horizontal compared to the horizontal plane 5 of the predetermined viewing position, it is also possible that the image surface 3 is not perfectly flat or regular. Thus, rather than being flat as shown in FIG. 4, the surface is likely to be undulating or non-even in practice. For example, the surface may comprise one or more bumps 50 as shown in FIG. 5, or one or more dips 60 as shown in FIG. 6, or any combination of bumps 50 and dips 60.

Therefore, it will be appreciated from the above that, rather than being flat and horizontal, the plane of the image surface 3 at the predetermined image position may slope towards or away from the predetermined viewing position, slope clockwise or anticlockwise when observed from the predetermined viewing position, and comprise one or more bumps or dips, or indeed any combination of these.

Consequently, if an inverse perspective transformation according to the prior art is applied to such a surface, the viewed image will be adversely affected in the following ways:

If the predetermined image position slopes towards the predetermined viewing position, the viewed image will appear elongated. If the predetermined image position slopes away from the predetermined viewing position, the viewed image will appear compressed. If the predetermined image position slopes clockwise or anticlockwise when observed from the predetermined viewing position, the viewed image will appear to take on a rotation and appear skewed. If the predetermined image position comprises one or more bumps or dips, the viewed image will appear to have the same bumps and dips.

According to the present invention one or more surface characteristics of the image surface 3 are determined and used to adapt the image transformation process, thereby compensating for any flaws or discrepancies in the image surface 3. For example, one such surface characteristic is the plane in which the image surface 3 lies relative to the transverse axis 9. Another surface characteristic is the plane in which the image surface 3 lies relative to the longitudinal axis 11. Another surface characteristic may be a contour map defining how the image surface 3 varies over the predetermined image position.

Prior to giving a more detailed description of how an original image is transformed according to the invention, a more detailed explanation will first be given about how an image is transformed according to the prior art.

Referring to FIG. 7, reference numeral 71 designates a television camera whose line of sight 72 extends at a small angle γ to the image surface 73. The line of sight 72 intersects the image surface 73 at a point P (the focal point). The video camera 71 is positioned at a vertical height H above the image plane and at a horizontal distance L from the focal point P.

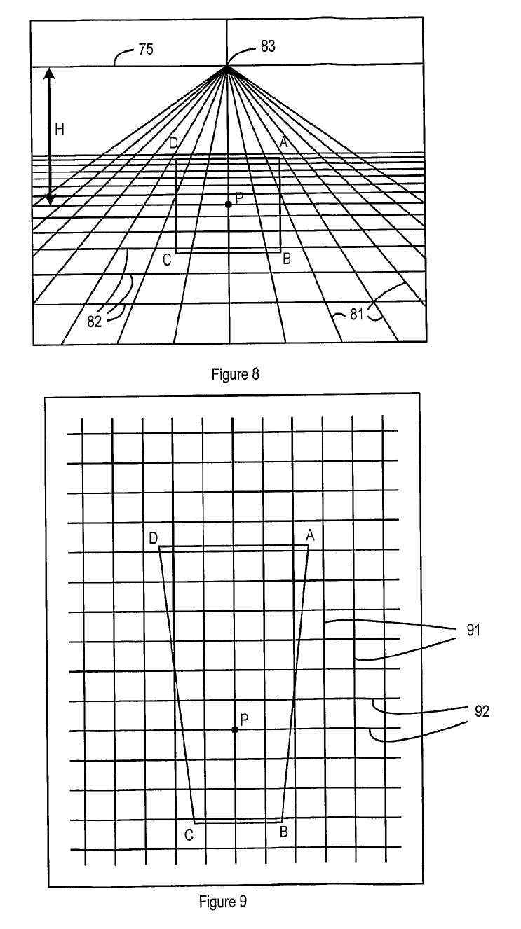

In FIG. 8 line ABCD indicates a rectangular shape with focal point P, superimposed on a perspective grid consisting of longitudinal lines 81 and transverse lines 82. The lines 81 and 82 represent lines that, in the plane of the image surface 73, form a regular rectangular grid. The longitudinal lines 81 thus converge to a vanishing point 83 on a horizontal line or “horizon” 75 and the transverse lines 82 appear to get closer and closer together as they recede into the distance. This is in accordance with the laws of perspective governing a regular rectangular grid with focal point P when it is viewed from an elevated position of vertical height H above the plane of the grid and a horizontal distance L from the focal point P.

When the perspective grid illustrated in FIG. 8 is transformed to a regular rectangular grid consisting of lines 91 and 92 as shown in FIG. 9, and a full inverse perspective transformation process according to the prior art applied to the rectangular shape ABCD, the shape ABCD becomes an elongated quadrilateral shape having parallel sides BC and AD and diverging sides BA and CD. FIG. 9 therefore discloses how a transformed image would appear according to the prior art when the original image has a rectangular shape.

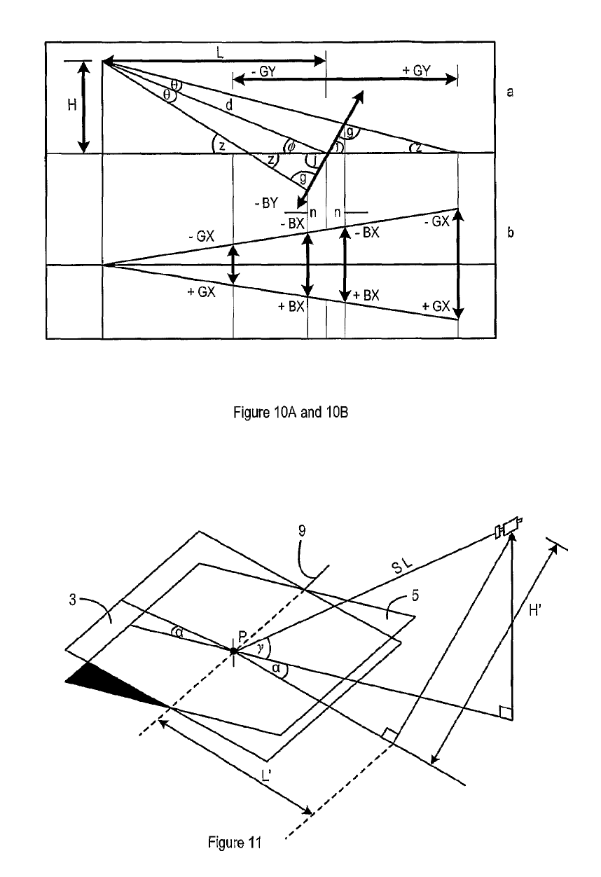

The transformation of co-ordinates of a viewed image superimposed on a perspective grid to co-ordinates in the image surface 73 can be represented mathematically as follows, the various symbols that are used in the equations being shown in FIGS. 10a and 10b.

A point at BX, BY superimposed on a perspective grid and referenced to the focal point P corresponds to a point at GX, GY in the image surface 73, referenced to the focal point P, such that:

$$\begin{matrix}GY = ( \frac{H}{tan z} ) - L & ( 1 ) \\ where & \\ z = ( Φ - θ ) & ( 2 ) \\ Φ = {tan}^{- 1} ( \frac{H}{L} ) & ( 3 ) \\ θ = {tan}^{- 1} ( \frac{BY}{d} ) & ( 4 ) \\ d = {( {H}^{2} + {L}^{2} )}^{1 / 2} & ( 5 )\end{matrix}$$

if BY is positive, θ is positive
if BY is negative, θ is negative
if θ is positive, z<Φ
if θ is negative, z>Φ
if BY is positive,

$$\frac{H}{tan z} > L ,$$

GY positive
if BY is negative,

$$\frac{H}{tan z} > L ,$$

GY negative
and

$$GX = ( \frac{H}{tan z} ) ⋆ ( \frac{BX}{L + n} ) \qquad ( 6 )$$

where

n=BY*(cos j) (7)

j=(2*tan⁻¹(1.0))−Φ (8)

From the above it can be seen that the image transformation process according to the prior art involves transforming an original image on the assumption that the image surface is both flat and horizontal.

A more detailed explanation will now be given of how the image transformation process of the prior art is adapted according to the invention.

According to the invention, one or more surface characteristics of the image surface 3 are determined, and used to adapt the image transformation process. In its simplest form, the invention characterises the image surface 3 as a single plane. Any orientation that the plane of the image surface 3 may take up in three-dimensional space can be quantified in terms of the degree of rotation that the plane of the image surface 3 takes from that of the horizontal plane, separately, about the transverse axis 9 and/or the longitudinal axis 11 passing through the focal point.

FIG. 11 shows the situation where the plane of the image surface 3 is rotated about the transverse axis 9 towards the predetermined viewing position by an angle α. The effect of the rotation of the surface towards the camera around an axis passing transversely through the focal point is to increase the camera height from H to H′, and shorten the camera distance from L to L′ as follows:

H′=SL*sin(γ+α)

L′=SL*cos(γ+α)

The effect of the rotation of the image surface 3 away from the predetermined viewing position around the transverse axis 9 would be to decrease the camera height H and lengthen the camera distance L.

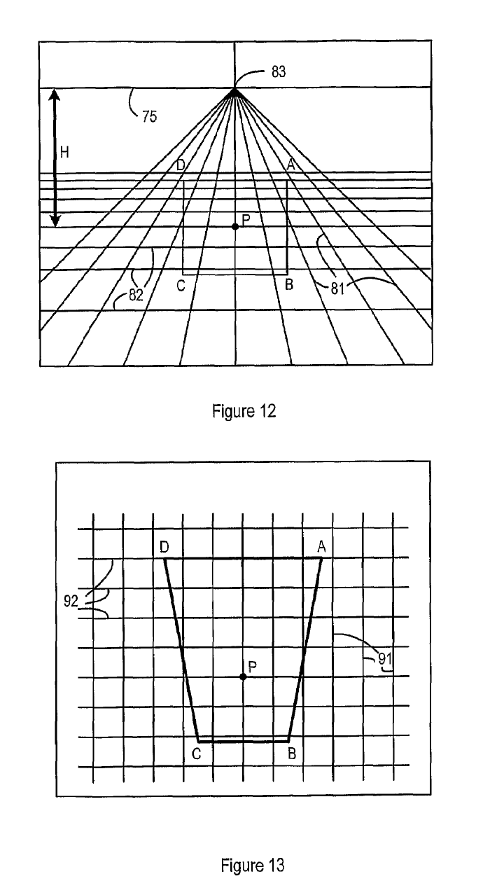

Using the above, a rotation in the plane of the image surface can be resolved back to the simple case of a horizontal plane prior to the image transformation being carried out. In other words, in its simplest form the invention determines the rotation of the plane of the image surface about the transverse axis 9, and adjusts the height and distance measurements accordingly, prior to performing an image transformation process. The effect of this increase in the camera height from H to H′ and shortening of the camera distance form L to L′ is illustrated in FIG. 12 where H is clearly shown to have increased and the grid appears to have opened up.

As a result, when the perspective grid illustrated in FIG. 12 is transformed to a regular rectangular grid as shown in FIG. 13, and a full inverse perspective transformation process applied to the rectangular shape ABCD, the shape ABCD has a less elongated quadrilateral shape. FIG. 13 therefore discloses how a transformed image would appear according to the present invention, as a result of an increase in the height H and a decrease in the distance L.

Thus, in FIG. 12 line ABCD indicates a rectangular shape with focal point P, wherein the image surface is depicted to be in a plane that is rotated as shown in FIG. 11 above (i.e. rotated about the transverse axis 9). The rectangular shape ABCD is superimposed on a perspective grid consisting of longitudinal lines 81 and transverse lines 82. The lines 81 and 82 represent lines that, in the plane of the image surface, form a regular rectangular grid. While the longitudinal lines 81 thus converge to a vanishing point 83 on a horizontal line or “horizon” 75 and the transverse lines 82 appear to get closer and closer together as they recede into the distance, compared to the perspective grid shown in FIG. 8, it will be appreciated how the height H has increased and accordingly the perspective grid has “opened up” to take into consideration the surface characteristics of the image surface. This is in accordance with the laws of perspective governing a regular rectangular grid with focal point P that has been rotated about the transverse axis 9, when it is viewed from an elevated position of vertical height H above and a horizontal distance L from the focal point P.

Therefore, as mentioned above, FIG. 13 shows how the transformed image appears when transformed according to the present invention. It will be appreciated that, compared to the transformed image shown in FIG. 9, the transformed image has been adapted to take into consideration the surface characteristics of the image surface. The transformed image shown in FIG. 13 therefore represents the image that must be positioned at the predetermined image position, so that the viewed image seen at the predetermined viewing position matches the original image that is intended to be displayed.

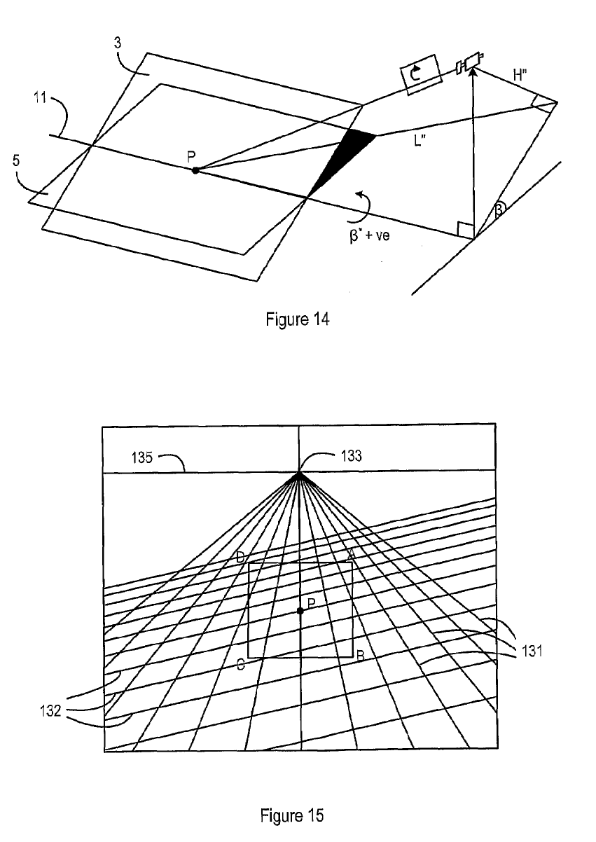

Referring to FIG. 14, the effect of a rotation β of the image surface 3 about the longitudinal axis 11 passing through the focal point P is to decrease the camera height to H″, lengthen the camera distance to L″ and necessitate a rotation of the original image by θ_{R} determined by the following formulae:

$$\begin{matrix}\begin{matrix} {H}^{″} = {H}^{′} ⋆ cos ( β ) \\ {L}^{″} = {( {( {H}^{′} ⋆ sin ( β ) )}^{2} + {( {L}^{′} )}^{2} )}^{\frac{1}{2}} \\ {θ}_{R} = {tan}^{- 1} ( {Q}_{by} / {Q}_{bx} )\end{matrix} & \\ where & \\ \begin{matrix} {Q}_{gx} = sin ( tan ( ( {H}^{′} ⋆ sin ( β ) ) / {L}^{′} ) ) \\ {Q}_{gy} = sin ( tan ( ( {H}^{′} ⋆ sin ( β ) ) / {L}^{′} ) ) \\ d = {( {{H}^{″}}^{2} + {{L}^{″}}^{2} )}^{\frac{1}{2}} \\ Φ = {tan}^{- 1} ( {H}^{″} / {L}^{″} ) \\ Z = {tan}^{- 1} ( {H}^{″} / ( {Q}_{gy} + {L}^{″} ) ) \\ θ = ( Φ - Z ) \\ {Q}_{by} = d ⋆ ( tan ( θ ) ) \\ n = {Q}_{by} ⋆ ( cos ( 2 ⋆ ( {tan}^{- 1} ( 1.0 ) ) - ( θ + Z ) ) ) \\ {Q}_{bx} = ( ( {L}^{″} + n ) ⋆ {Q}_{gx} ) / ( {L}^{″} + {Q}_{gy} )\end{matrix} & \end{matrix}$$

Using the above, a rotation of the plane of the image surface about the longitudinal axis 11 can be resolved back to the simple case of a horizontal plane prior to the image transformation being carried out. In other words, after the image has been normalised with respect to a rotation of the image surface about the transverse axis 9, the invention determines the rotation of the plane of the image surface about the longitudinal axis 11, and further adjusts the height and distance measurements accordingly and effects a rotation of the original image, prior to performing an image transformation process.

In FIG. 15 line ABCD indicates a rectangular shape with focal point P, wherein the image surface is depicted to be in a plane that is rotated as shown in FIGS. 11 and 14 above (i.e. rotated about the transverse axis 9 and the longitudinal axis 11). The rectangular shape ABCD is superimposed on a perspective grid consisting of longitudinal lines 131 and transverse lines 132. The lines 131 and 132 represent lines that, in the plane of the image surface, form a regular rectangular grid. The longitudinal lines 131 thus converge to a vanishing point 133 on a horizontal line or “horizon” 135 and the transverse lines 132 lie at an angle to the horizon and appear to get closer and closer together as they recede into the distance. This is in accordance with the laws of perspective governing a regular rectangular grid with focal point P that has been rotated about the transverse axis 9 and the longitudinal axis 11, when it is viewed from an elevated position of vertical height H above and a horizontal distance L from the focal point P.

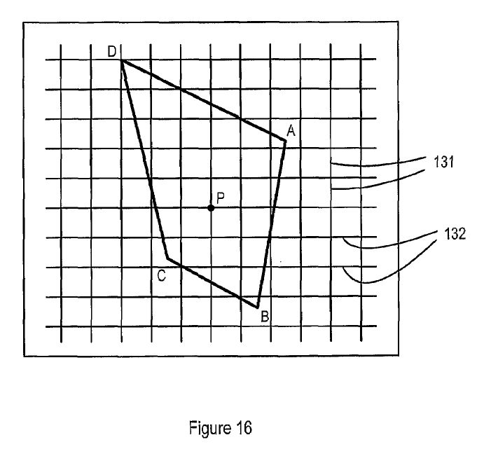

FIG. 16 shows how the transformed image appears when transformed according to the present invention. Thus, compared to the transformed image shown in FIG. 9, it will be appreciated how the transformed image has been adapted to take into consideration the surface characteristics of the image surface. The transformed image shown in FIG. 16 therefore represents the image that must be positioned at the predetermined image position, so that the viewed image seen at the predetermined viewing position matches the original image that is intended to be displayed.

Thus, the invention provides a method whereby one or more surface characteristics of the image surface can be used firstly, to correct the camera height and distance in respect of the degree of rotation a that the image surface 3 takes from that of the horizontal plane 5 about the transverse axis 9 and secondly, to correct the camera height and distance and rotation of the image surface 3 in respect of the degree of rotation β about the longitudinal axis 11.

It will be appreciated that the invention can apply these corrections in any order, i.e. to correct for rotation about the longitudinal axis 11 prior to performing a correction for rotation about the transverse axis 9, or be used to correct for just one such rotation.

In this way, it is possible to calculate an inverse perspective transformation of an image for a flat surface at any orientation in three-dimensional space.

The embodiment described above is based on the assumption that the image surface is flat, thereby allowing the image surface to be characterised in terms of its plane lying in a plane that is rotated about the transverse axis 9 and/or longitudinal axis 11.

According to another aspect of the invention, the image surface 3 is partitioned into a plurality of sections, each separate section being treated as flat, such that each section can be characterised as lying in a plane that is rotated about the transverse axis 9 and/or longitudinal axis 11, as described above.

Preferably, the number of separate sections is chosen according to how non-uniform a particular image surface is in reality. For example, if the image surface comprises a large number of bumps or dips, then the image surface is partitioned into a larger number of sections compared to an image surface that has fewer irregularities. This enables a non-uniform surface to be simplified into a number of individual surfaces, each appropriately small enough to be considered flat, and each lying at various orientations in three dimensional space.

The plurality of sections enable the surface contour characteristics of the image surface to be represented.

One method of determining the surface characteristics of the image surface is to place a first set of parallel string lines over the image area in a first direction that is parallel to the transverse axis, and to place a second set of string lines over the image surface in a second direction that is parallel to the longitudinal axis. The number of strings in each set is chosen in order to provide the required number of sections. The image surface is then imaged, and the imaged data used to determine the plane in which each section lies.

It will be appreciated that other techniques can be used to determine the plane in which each section lies. For example, the image surface can be surveyed using conventional surveying techniques in order to plot out the contours of the image surface.

Once the orientation of each section has been determined, the effective height and distance measurements are then adjusted accordingly for each section, as described above in relation to the first embodiment. An image transformation process for a non-uniform surface therefore, will comprise of a collection of individual image transformations of parts of the image which correspond to individual sections that form part of the image surface, each section being small enough to be considered flat and that exists at some orientation in three-dimensional space.

Preferably, the image transformation process comprises a full inverse perspective transformation in which the original image is progressively stretched along the line of sight, such that equal distances in the original image become progressively longer in the transformed image along the line of sight, and wherein image points in the original image diverge along the line of sight.

However, it will be appreciated that the inverse perspective transformation can also comprise the step of: just stretching the original image along a line of sight between the predetermined viewing position and the predetermined image position; progressively stretching the original image along the line of sight, such that equal distances in the original image become progressively longer in the transformed image along the line of sight; or just diverging image points in the original image along the line of sight.

Where the ground surface is a playing field for sporting events, the transformed image may be applied to the surface by means of chalk, paint or a similar like marking material. TV coverage of the sporting event will cause the image to be displayed on the TV screen of every person watching the sporting event on TV. The observer will, by a process of mental or visual interpretation, visualise the image on the TV screen in the form the image had prior to the transformation and the image will thus appear to be stand out from its surroundings, for example lie in a plane at right angles to the observer's line of vision. This will increase its impact on the TV audience.

It will be appreciated that the creation of the transformed image from the original image can readily be done by means of a computer. The transformed image is then applied to the image surface at the predetermined image position.

Once a transformed image has been created according to the techniques described above, the transformed image may then be applied to an image carrier, for example a mat, for placement on the image surface at the predetermined image position. Alternatively, the transformed image can be painted directly onto the image surface.

With the latter, a template containing the transformed image is typically used to mark the image surface, which is then painted with the appropriate colours corresponding to the original image.

According to another aspect of the invention, there is provided an improved method for transferring the transformed image onto the image surface by means of a multi-layer print template.

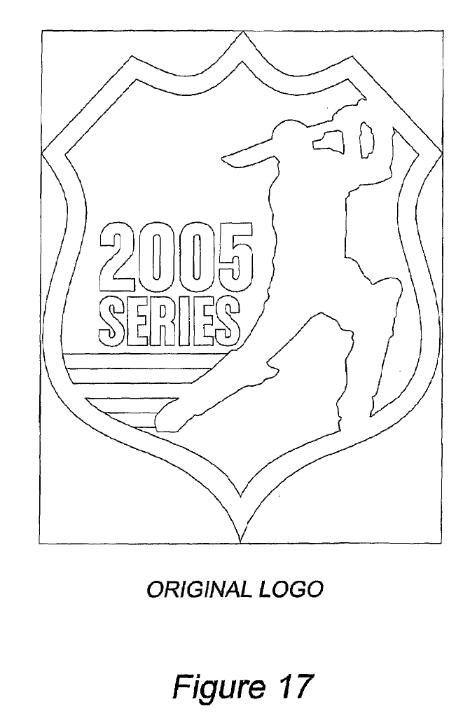

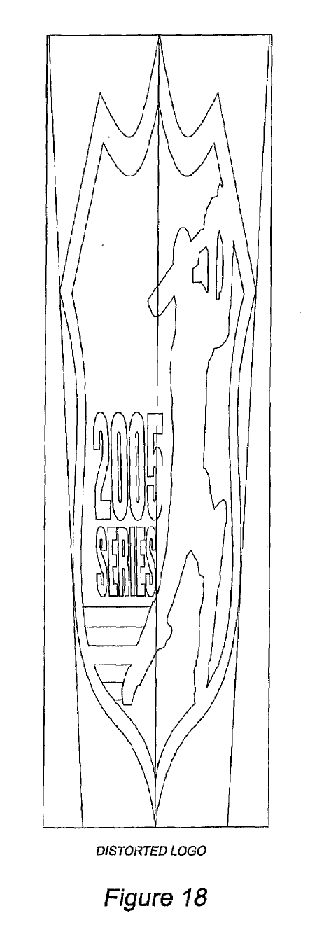

Typically, the transformed image of a sponsor's branding can be in excess of an area measuring 8 metres by 15 metres. In other words, an original image such as that shown in FIG. 17 becomes much larger after undergoing an image transformation process, for example as illustrated by the transformed image shown in FIG. 18. All of the information pertaining to the sponsor's branding is contained within the full extent of this transformed image, and needs to be transferred onto the surface exactly and in its entirety.

In order to carry this out accurately, it is necessary to produce a template that carries this information at 1:1 scale (i.e. full-size). To produce a full-size template of the entire transformed image, however, is both uneconomical and impractical. Such a method would be uneconomical because there are many areas within the transformed image that carry no information (e.g. white space) and it is therefore unnecessary to utilise expensive template material for this purpose. The method is also impractical because this tends to be an outdoor operation in which the template is exposed to the elements and understandably the wind and rain can severely hamper the process of applying the transformed image onto the surface with such a large template, which also leads to inaccuracy.

The smaller the template, the more manageable the template is for carrying out the accurate transferral of information onto the image surface.

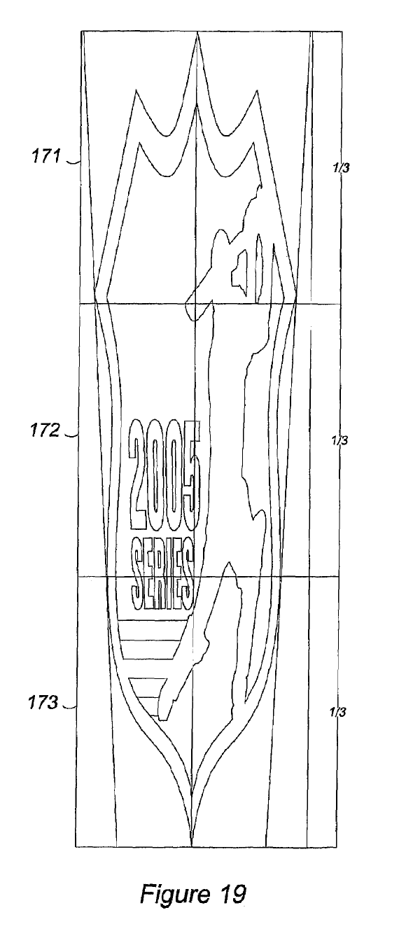

One solution would be to produce a full-size template, but in smaller, manageable sections as shown in FIG. 19. Each section 171 to 173 would be placed one at a time, positioned accurately in accordance with layout instructions. However, this technique still requires a large amount of template material.

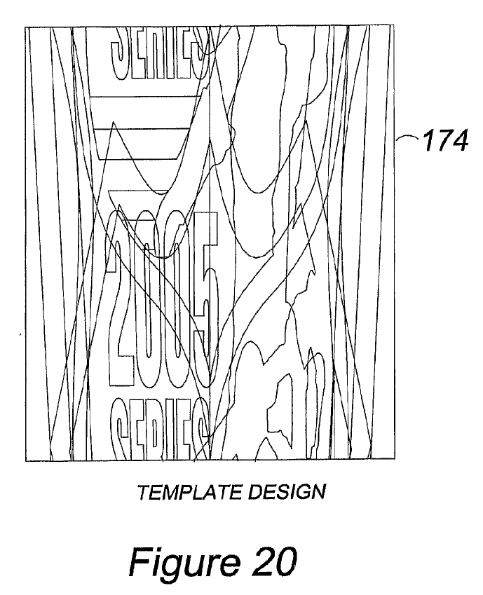

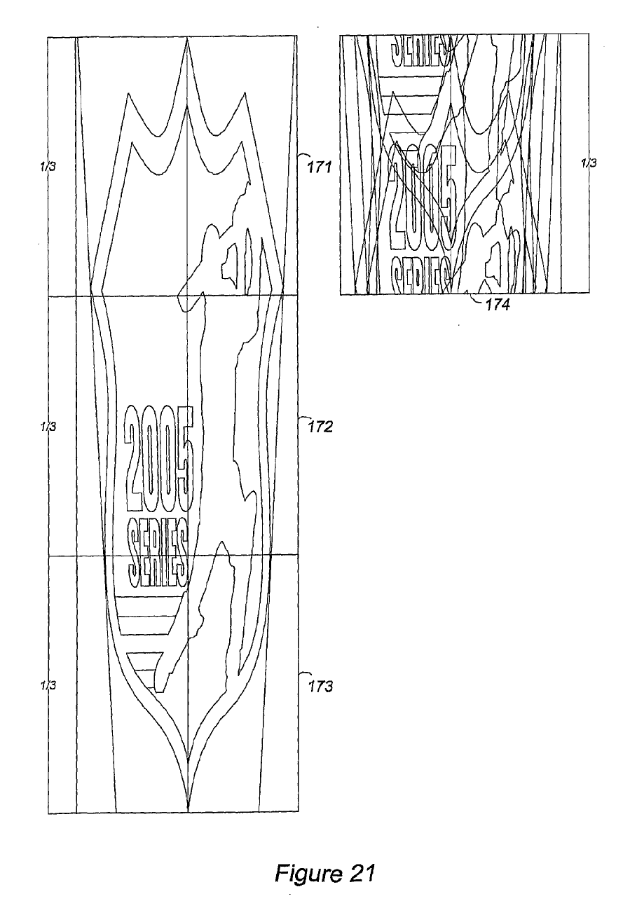

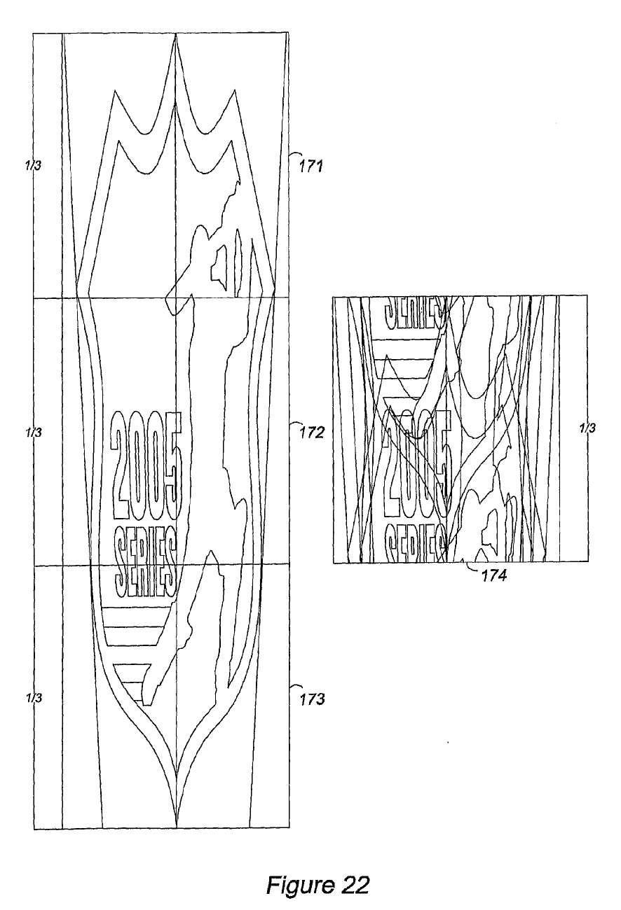

According to this further aspect of the invention, the template is partitioned into a number of smaller sections, with all of the information contained on each of these smaller sections being printed onto one single smaller sized template, as shown in FIG. 20. This single template is then laid down over and over in a series of repeat placements. Each placement is positioned accurately in accordance with layout instructions, and each position relates to a different piece of information on the template. For ease of recognition, each piece of information is preferably printed in a different colour.

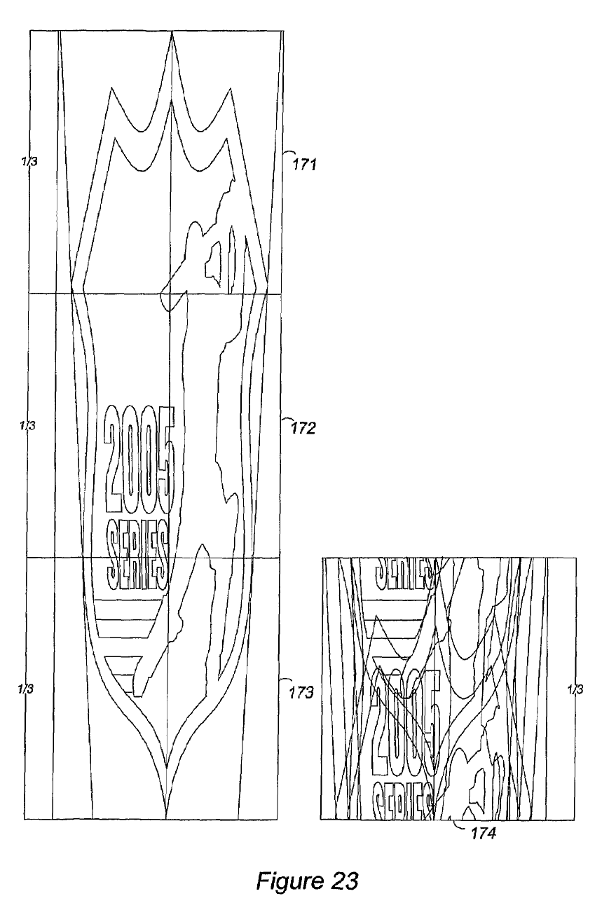

FIG. 21 shows where the template design corresponding to the top section 171 appears in the single template shown in FIG. 20. Likewise, FIG. 22 shows where the template design corresponding to the middle section 172 appears in the single template shown in FIG. 20, while FIG. 23 shows where the template design corresponding to the bottom section 173 appears in the single template shown in FIG. 20.

Thus, as will be seen from the above, this aspect of the invention has the advantage of enabling a large template to be reproduced using a smaller template having a plurality of template portions overlaid in the same physical template.

Although the preferred embodiment refers to the original image as being of an advertising or promotional nature, it will be appreciated that the original image can be any type of image.

Also although the image surface has been described as relating to a playing surface or field for a sporting event, it will be appreciated that the surface may be any type of surface.

In addition, although the preferred embodiment describes a camera being positioned at the predetermined viewing position to view the image, it will be appreciated that a camera is not necessarily required, and the image may be viewed by any other means, including directly by a person located at the predetermined viewing position. If a camera is present, the output of the camera may be broadcast or diffused in a television broadcasting or diffusion service.

Furthermore, although the invention is described in relation to the predetermined viewing position being above the image surface, for example a television camera imaging a playing field, it will also be appreciated that the invention is equally applicable to applications in which the image surface is a ceiling or the like, in which the image is viewed from below or a wall which is viewed from an oblique angle.

Also, although the focal point P has been described as being in the centre of a particular image, the invention could also be realised using a focal point P which is located at some other predetermined part of the image.

Finally, although the preferred embodiment is based on adjusting certain parameters prior to carrying out a “standard” transformation process, it will be appreciated that the image transformation process itself can be adapted to receive the one or more surface characteristics directly, and to perform the image transformation process directly or simultaneously using this input information.

1. A method of depicting an image at a predetermined image position, the method comprising the steps of:
transforming an original image using an image transformation process, the image transformation process being adapted to transform the original image according to a positional relationship between the predetermined image position and a predetermined viewing position, thereby creating a transformed image for placement on an image surface at said predetermined image position;
wherein the step of transforming the original image includes the steps of:
determining one or more surface characteristics of the image surface; and adapting the image transformation process according to the one or more surface characteristics of the image surface.

2. A method as claimed in claim 1, wherein the image transformation process comprises the step of stretching the original image along a line of sight between the predetermined viewing position and the predetermined image position.

3. A method as claimed in claim 2, wherein the step of stretching the original image comprises the step of progressively stretching the original image along the line of sight, such that equal distances in the original image become progressively longer in the transformed image along the line of sight.

4. A method as claimed in claim 1, wherein the image transformation process comprises the step of diverging image points in the original image along a line of sight.

5. A method as claimed in claim 1, wherein the image transformation process transforms the original image in relation to a height and distance of the predetermined viewing position from the predetermined image position.

6. A method as claimed in claim 1, wherein the step of adapting the image transformation process comprises the steps of:
determining how a plane of the image surface differs from a substantially horizontal plane; and
adapting the transformed image to compensate for the difference between the plane of the image surface and the horizontal plane.

7. A method as claimed in claim 6, further comprising the step of characterising the plane of the image surface into a first plane which rotates on a transverse axis relative to a line of sight, thereby enabling the image transformation process to compensate for at least one of the following:
the plane of the image surface being inclined towards the predetermined viewing position; and
the plane of the image surface being inclined away from the predetermined viewing position.

8. A method as claimed in claim 7, comprising adjusting effective height and distance measurements of the predetermined viewing position from the predetermined image position according to the degree of rotation about the transverse axis, prior to the measurements being used in the image transformation process.

9. A method as claimed in claim 6, further comprising the step of characterising the plane of the image surface into a second plane which rotates on a longitudinal axis relative to a line of sight, thereby enabling the image transformation process to compensate for at least one of the following:
the plane of the image surface being rotated clockwise in relation to the horizontal plane as observed from the predetermined viewing position; and
the plane of the image surface being rotated anti-clockwise in relation to the horizontal plane as observed from the predetermined viewing position.

10. A method as claimed in claim 9, comprising adjusting effective height and distance measurements of the predetermined viewing position from the predetermined image position as well as effecting a rotation of the image to be transformed according to the degree of rotation about the longitudinal axis.

11. A method as claimed in claim 6, further comprising the steps of:
partitioning the image surface into a plurality of sections;
determining one or more surface characteristics for each of the plurality of sections; and
performing a separate image transformation process on each corresponding section of the original image, wherein the image transformation process on each section is adapted according to the surface characteristics of the corresponding section on the image surface.

12. A method as claimed in claim 1, further comprising the step of positioning at least one of the following at the predetermined viewing position so that the viewed image can be viewed remotely;
an image recording; and
a transmitting device.

13. A method as claimed in claim 12, wherein at least one of the following comprises a camera for broadcasting the viewed image:
the image recording; and
the transmitting device.

14. A method as claimed in claim 1, wherein the image surface is at least one of the following:
a playing surface for a sporting event; and
a field for a sporting event.

15. A method as claimed in claim 1, where the transformed image is applied to an image carrier, the image carrier being applied to the image surface.

16. A method as claimed in claim 15, wherein the image carrier is made from a material that adapts its shape in relation to the shape of the image surface.

17. A method as claimed in claim 16, wherein the image carrier is a mat.

18. A method as claimed in claim 1, where the transformed image is applied directly to the image surface.

19. A method as claimed in claim 18, wherein a template is used to apply the transformed image onto the image surface.

20. A method as claimed in claim 19, wherein the template size is smaller than the size of the transformed image.

21. A method as claimed in claim 20, wherein the transformed image is separated into two or more sections, each section being overlaid on the same template.

22. A method as claimed in claim 1, wherein the original image is at least one of the following:
an advertising image; and
a promotional image.
